(19) United States
(12) Patent Application Publication
(10) Pub. No.: US 2016/0364808 A1
(43) Pub. Date: Dec. 15, 2016

(54) SYSTEM AND METHOD FOR AN AUTOMATED TAX PREPARATION KIOSK

(71) Applicant: Mario A. Costanz, New Rochelle, NY (US)

(72) Inventor: Mario A. Costanz, New Rochelle, NY (US)

(21) Appl. No.: 15/246,548

(22) Filed: Aug. 25, 2016

Related U.S. Application Data
(63) Continuation of application No. 15/095,006, filed on Apr. 8, 2016.
(60) Provisional application No. 62/145,165, filed on Apr. 9, 2015.

(51) Int. Cl. G06Q 40/00; G06Q 20/18

(52) U.S. Cl. CPC G06Q 40/123; G06Q 20/18

(57) ABSTRACT

A system for receiving tax information at a kiosk for efficient processing of tax preparation services by centralized and distributed tax preparation resources, comprising a local processing server that receives interaction from a plurality of user devices, transmits information to a remote or distributed processing center via a network, and provides local processing in the event of the centralized processing center or to handle overflow. The kiosk further configured to receive requests from other network-connected system to process tax documents locally.

### CROSS-REFERENCE TO RELATED APPLICATIONS

This application is a continuation of U.S. patent application Ser. No. 15/095,006 titled, “SYSTEM AND METHOD FOR EFFICIENT PROCESSING OF TAX PREPARATION SERVICES BY CENTRALIZED AND DISTRIBUTED TAX RESOURCES” filed on Apr. 8, 2016, which claims the benefit of, and priority to, U.S. provisional patent application 62/145,165 titled, “SYSTEM AND METHOD FOR EFFICIENT PROCESSING OF TAX PREPARATION SERVICES BY CENTRALIZED AND DISTRIBUTED TAX RESOURCES” filed on Apr. 9, 2015, the entire specifications of which are each incorporated herein by reference.

### BACKGROUND OF THE INVENTION

### Field of the Art

The disclosure relates to the field of tax preparation services, and more particularly to the field of the efficient delivery of tax preparation services by centralizing and distributing work amongst a group of tax professionals.

### Discussion of the State of the Art

The two main business models for assisted tax preparation businesses are a) for tax clients to go to a tax preparer, who would sometimes have very little training, which may result in low-quality work, and b) Certified Personal Accountants (CPAs) who tended to do high-quality work, may charge more partly because of the overhead of CPAs, which includes dedicated offices, staff, and advertising.

What is needed is allowing tax preparation clients to have access to a CPA's expertise without having to pay the fees that a CPA would normally charge by centralizing and distributing work to CPAs in a secure and trustworthy fashion.

### SUMMARY OF THE INVENTION

Accordingly, the inventor has conceived and reduced to practice, in a preferred embodiment of the invention, a system and method for the centralization and distribution of tax preparation services to reduce tax preparation cost and create a more affordable efficient tax preparation environment while maintaining a high-level of quality in tax preparation.

In a preferred embodiment tax preparation clients get the benefit of a CPA's expertise by having a CPA prepare their tax returns, combined with the accessibility of being able to interface with representatives in neighborhood locations, including, but not limited to, shopping malls, other retail locations and at a client's home or other meeting place. The CPAs who prepare the clients' tax returns get to enjoy reduced overhead, and easier access to clients. Therefore, clients are able to have CPAs prepare their tax returns at reduced costs.

In a preferred embodiment, a method using computer databases that include the tax clients' financial information, using a dedicated or distributed tax preparation remote processing center staffed by CPAs, and using computerized scanners that can scan documents, and using devices and computer programs with the capability to transmit scanned documents via the

Internet, either through wires, or wirelessly is disclosed. It is a system through which a tax client enters a retail location or meets with a representative at a common place where the clients W2s, 1099s, other tax forms and other relevant information for the tax client are scanned by a retail center employee, and then copies of these documents are electronically transmitted to the remote center where the CPAs work on the client's tax returns. They complete the client's tax returns or ask for additional information, and the resulting tax return created by the CPAs' activity is transmitted to electronic devices at the retail center or directly back to the client's smartphone, where the tax client looks over the return, approves it, and signs it electronically, or on paper, and the return is then sent to the IRS electronically.

In a preferred embodiment, the problem of allowing tax preparation clients to have access to a CPA's expertise without having to pay the fees that a CPA would normally charge is solved. This is because the overhead associated with the CPA is reduced. In some embodiments, a large number of CPAs are grouped together in a dedicated center, in other embodiments, CPAs may be home-based workers working remotely from the processing center. This saves money on overhead and support staff, which translates into lower costs for the clients. In addition, this embodiment solves the problem of making it easier for CPAs to get access to a potential client base, without having to pay high overhead or advertising costs. It also gives tax preparation clients freedom to do other things while their tax returns are being prepared instead of having to sit across from the person preparing the return.

In a preferred embodiment, the elements of the two business models by using dedicated technology running on a specialized computer in an innovative fashion are combined. The embodiment seeks to give tax clients access to CPA-level expertise to prepare their tax returns, at a reduced cost. The embodiment also seeks to help CPAs get access to potential clients more easily. The embodiment also solves the problem that individual tax filers have often encountered, through which they may not have access to their tax-related data after they have filed it. The embodiment keeps this data in a safe electronic location.

Individual tax preparation clients and certified public accountants (CPAs) would use the invention. Individual “reps” who can visit tax clients in their homes or elsewhere, and get their tax data via a mobile user device, would also benefit, because they would earn money based on their interactions with the tax clients.

Benefits to the user who is a consumer include having his or her taxes prepared by a professional with expertise in the tax laws specific to the requirements of the customer, and also would include having a permanent electronic copy of his or her tax information available, and would also include being in comfortable surroundings while his tax information is being prepared.

In some embodiments, the retail center, and the inside customer service representatives gather tax preparation documents from the tax clients and send this information to the remote processing center. The outside customer service representative gather tax preparation documents from the tax clients, electronically scan or capture the documents via a user device and send this information to the remote processing center.

The invention functions by electronically getting the relevant tax return documents for each tax client to a staff of dedicated CPAs who have specific skills based on the information within the provided documents and have access to a tax preparation program that they can use to prepare tax returns. The prepared returns are then electronically sent from the remote processing center to the tax client, whether the tax client is at a retail center or at the client's home.

In a preferred embodiment, the tax client's tax data is scanned via a user device and sent, for example, via the Internet, POTS, wireless, etc. to a remote or distributed processing center that has a dedicated staff of CPAs present, who can prepare the tax client's tax return in real time. The second unique feature is that “outside reps” can take pictures of the tax data of a tax client, and the data can then be sent via the Internet to the CPAs at the remote processing center. In another embodiment, tax clients can have their tax returns prepared by professional CPAs from the comfort of their own homes and have the data accurately returned to them, and corrected in real time, from the comfort of their own homes. In this regard, tax clients can have copies of their tax data and tax returns stored in the central database of the firm, which may be important to a tax client, for example in the instance where the tax client is audited.

In a preferred embodiment, one or more trained CPAs, and a location (a remote or distributed processing center) where the CPAs can receive electronic copies of tax clients' tax preparation documents, can prepare tax returns, and can send electronic copies of the tax clients' tax returns over the Internet to the tax clients.

In a preferred embodiment, a central database, which is electronically connected to the remote processing center via the Internet, and on which the tax clients' tax preparation documents, and tax returns, are stored, may be used.

In a preferred embodiment, a tax preparation program, which the CPAs will use to prepare tax clients' tax returns may be used. This may be accessible via computer for the CPAs at the remote processing center. The tax preparation program will help the CPAs to analyze tax clients' tax preparation documents quickly and prepare tax clients' tax returns quickly.

One embodiment of the invention requires retail centers where tax clients can have their tax preparation documents scanned. These retail centers will be staffed by inside customer service representatives, and the inside customer service representatives will arrange for copies of the tax clients' tax preparation documents to be sent over the Internet to the remote or distributed processing center. They will also inform a waiting tax client that his or her tax return has been prepared, discuss the results of the tax return, and make the tax return available for the client to electronically sign it, if so desired.

In another embodiment, outside customer service representatives, who are specially trained, will visit tax clients and scan electronic copies of the tax clients' tax preparation documents, which will be sent to the remote processing center. The remote processing center will send back an electronic copy of the tax client's prepared tax return.

In a preferred embodiment, highly trained staff will be staffing the locations.

In another embodiment of the invention, an outside customer service representative visits the tax client at his or her residence, or another location of the tax client's choosing. In this regard, the outside customer service representative may use a user device capable of transcribing or scanning documents to make an electronic copy of the tax client's tax preparation documents, then send this copy to the remote or distributed processing center to have the tax return prepared, and receive an electronic copy of the tax client's prepared tax return back from the remote processing center.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an efficient and remote tax preparation environment, according to a preferred embodiment of the invention.

FIG. 6 is a flow diagram of an exemplary method of remote tax preparation, according to a preferred embodiment of the invention.

FIG. 7 is a flow diagram of an exemplary method of remote tax preparation with capacity failover, according to a preferred embodiment of the invention.

FIG. 8 is a flow diagram of an exemplary method of a highly available remote tax preparation system, according to a preferred embodiment of the invention.

FIG. 9 is a flow diagram of an exemplary method of automatically identifying skills for a tax preparation system, according to a preferred embodiment of the invention.

FIG. 10 is a flow diagram of an exemplary method of assigning skills to tax preparers in a tax preparation system, according to a preferred embodiment of the invention.

FIG. 11 is a flow diagram of an exemplary method of automatically routing tax information to the best resource in a tax preparation system, according to a preferred embodiment of the invention.

### DETAILED DESCRIPTION

The inventor has conceived, and reduced to practice, a system and method for efficient processing of tax preparation services by centralized and distributed tax resources.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

“Tax preparation documents”, as used herein, refers to the documents that a CPA generally requires, in order to prepare a tax client's tax return. These include, but are not limited to, pay stubs, IRS form 1099s, and bank statements where appropriate.

“Tax return”, as used herein, refers to a prepared tax return that is ready to be filed with the IRS, once the tax client has signed it.

“CPA”, as used herein, refers to a certified public accountant, who has achieved the designation of certified public accountant. In other embodiments, other professional designations may be used in various embodiments of the present invention. It should be appreciated by one with ordinary skill that CPA as used generically in the instant application to refers to a tax professional who has the proper designation to prepare tax returns in a particular jurisdiction. In some embodiments, CPAs are referred to as agents.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

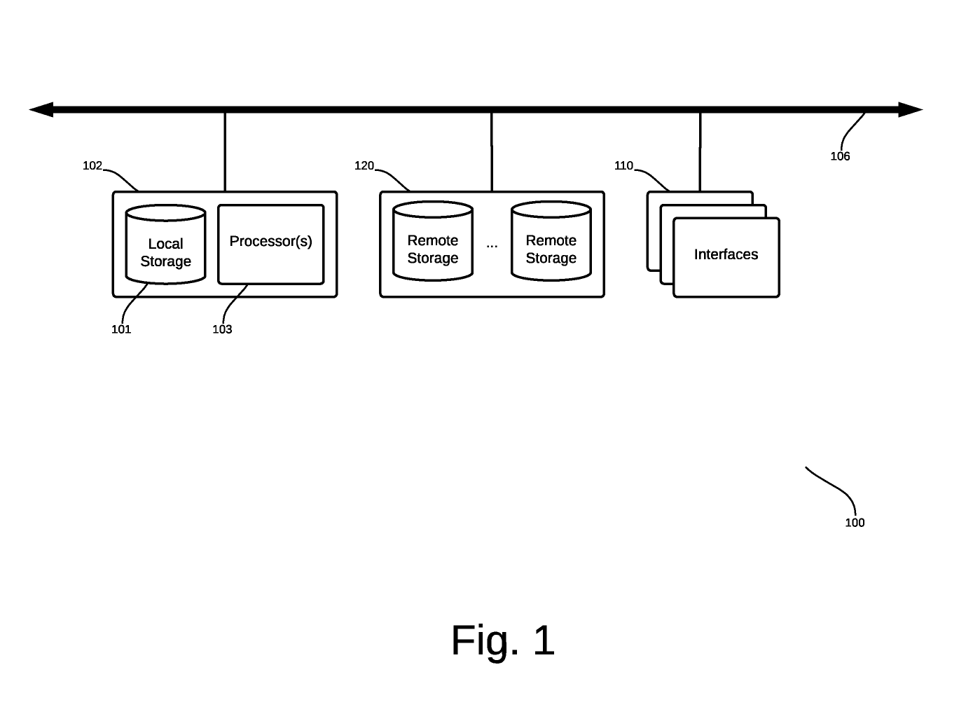

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD- ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JavaTM compiler and may be executed using a Java virtual machine or equivalent, or files containing higher level code that may be executed by the computer using an interpreter (for example, scripts written in Python, Perl, Ruby, Groovy, or any other scripting language).

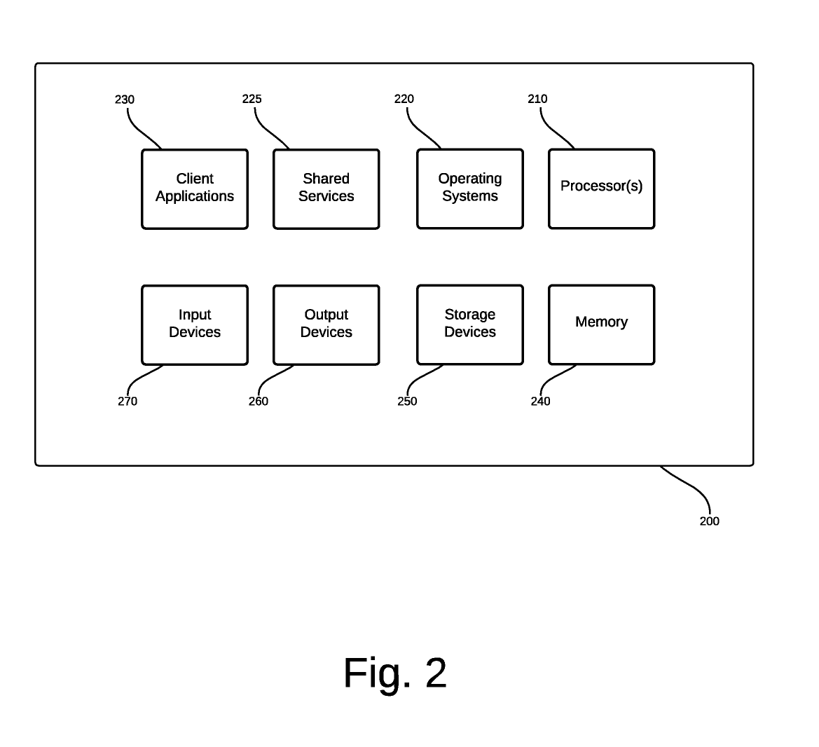

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WiNDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

In some embodiments, systems of the present invention may be implemented on a distributed computing network, such as one having any number of clients and/or servers.

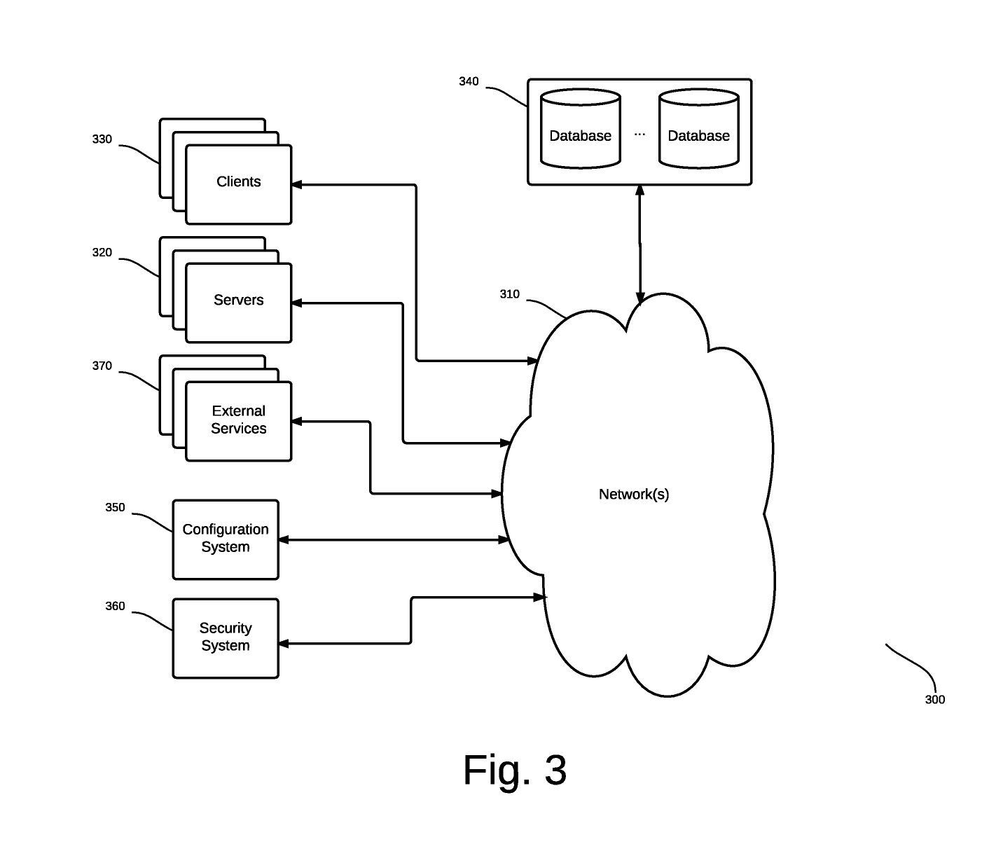

Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

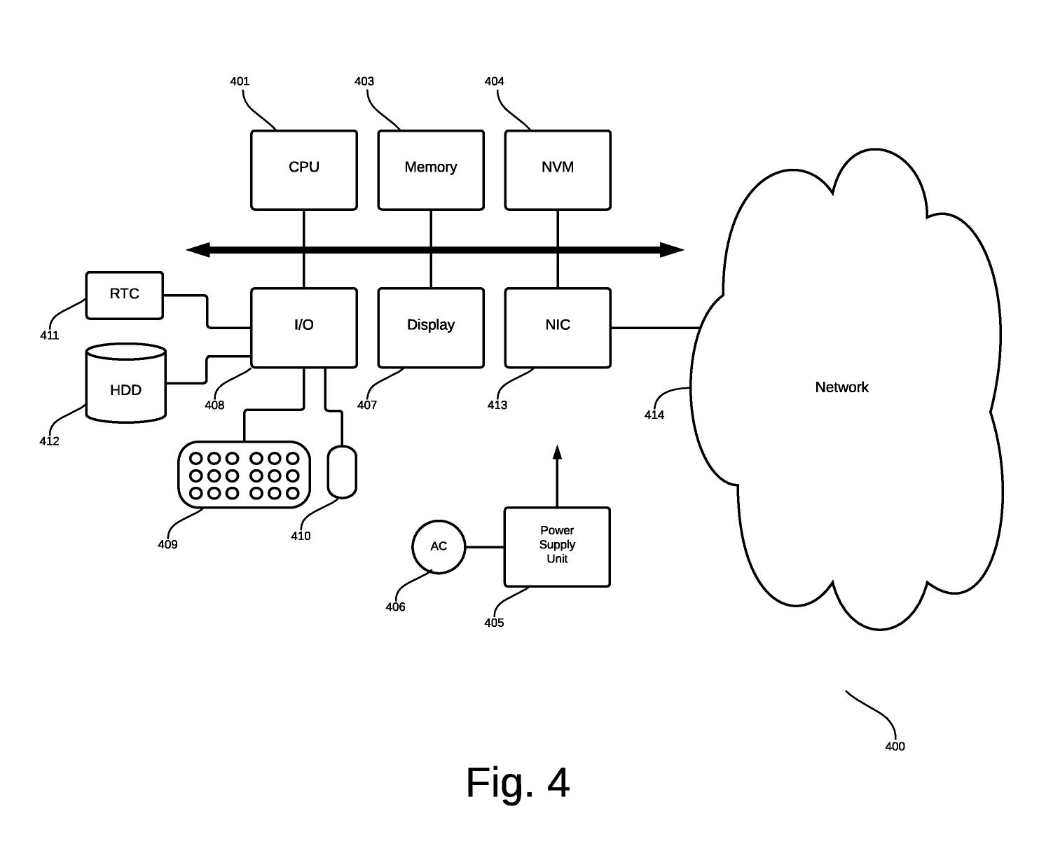

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

The remote or distributed processing center will be staffed by CPAs who may have annual training on updates to tax law and also training using the tax preparation program.

The method begins when the tax client enters a retail center, and interacts with an inside customer service representative, who uses the transcribing program to gather and transcribe the tax client's tax return documents and data into electronic format. These are then sent via the inbound scanning and sending component, over the Internet, to the remote or distributed processing center, and they may also be stored on a central database at this time.

At the remote or distributed processing center, the CPAs use the tax preparation software program to create a tax return document for the tax client from the tax preparation documents that the retail center has sent. The tax return may also be stored on the central database at this time.

The tax return is then sent to the retail center from which the tax preparation documents were originally sent or directly back to the client. One of the inside customer service representatives then reviews the tax client's tax return with the tax client, the tax client electronically signs the tax return, and it is sent to the IRS.

In a second embodiment, the method begins when an outside customer service representative meets with the tax client, and uses a wireless computer device equipped with a computer transcribing program, and an inbound scanning and sending component, to the remote processing center. The method then proceeds in a manner similar to the first embodiment.

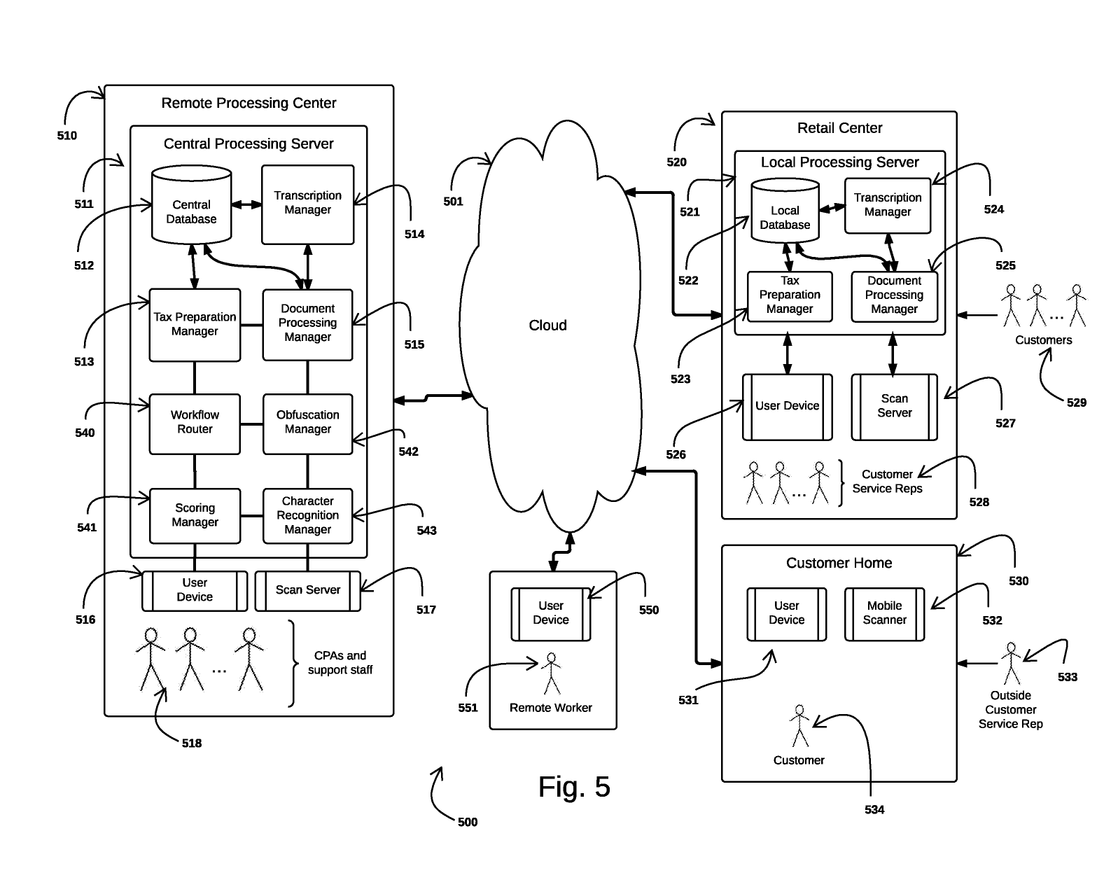

FIG. 5 is a block diagram of a system for efficient processing of tax preparation services by centralized and distributed tax resources. System 500 comprises a networking cloud 501 which may be, for example, the Internet, a cellular data or voice network, LAN, WAN, or POTS telephone network, or any other suitable data communication network. Remote processing center 510 may comprise a location fully or partially staffed by CPAs who prepare tax returns on behalf of tax clients. Central processing server 511 manages incoming transmission, transcriptions, central database and tax preparation software. Central database 512 may comprise a computer database, which may receive customer information including but not limited to customer profile and payment information, raw scans of tax information, transcribed tax information, IRS connection information for e-filing, etc. from the Internet, on which electronic copies of tax preparation documents and prepared tax returns can be stored, and organized according to the identities of the tax clients filing the returns. In some embodiments customer database 512 may include tax preparer skill information. Tax preparation manager 513 may be an off-the-shelf tax preparation software, or a custom-built software application for processing customer tax information. Transcription manager 514 transcribes documents (for example, scanned documents) received from document processing manager 515. Document processing manager 515 may receive documents from user device 516, scan server 517, or from communications with cloud 501 (for example from retail center 520 or customer home 530. User device 516 may be a computer comprised of a processor, memory, and storage; a mobile device such as a mobile phone, tablet, or wearable electronic device, etc. to interface to central processing server 511 for example, to view customer data, transcriptions, and the like. Scan server 517 may be used to receive and transmit data from the cloud (for example data transmitted from retail center 520, mobile scanner 532, etc. CPAs and/or support staff 518 may be a plurality of individuals that perform the functions of the instant invention.

Retail center 520 may be a dedicated retail location, such as a store in a shopping mall or a standalone building providing services to clients, where tax clients may go, and have their tax preparation documents scanned into electronic format and sent to the remote processing center. Local processing server 521 may be used in the same manner as central processing server 511. In a preferred embodiment, a plurality of retail centers 520 with a plurality of local processing servers 521 may handle fault tolerance in the event of a connection failure from cloud 501. In another preferred embodiment, local processing center 521 may handle overflow tasks from another retail center 520 or remote processing center 510 in the event of overcapacity. Local database 522 may keep a local version of customer data in the event of a connection failure to remote processing server 510 (for example, if cloud 501 becomes unavailable). In some embodiments, local database 522 may keep customer profile information to facilitate the routing of tasks to properly skilled individuals. Tax preparation manager 523 may be an off-the-shelf tax preparation software, or a custom built software application for processing customer tax information. Transcript Manager 524 A local version of transcription manager 514. Document processing manager 525 A local version of document processing manager 515. User device 526 may be a computer comprised of a processor, memory, and storage; a mobile device such as a mobile phone, tablet, or wearable electronic device, etc. to interface to local processing server 521 for example, to view customer data, transcriptions, and the like. Scan server 527 may comprise a local version of scan server 517. Customer Service representatives 528 A plurality of individuals that perform the functions of the instant invention. Tax clients 529 A plurality of tax clients who need an income tax return to be filed. Customer home 530 is a customer dwelling where “house call” services may be delivered. Services rendered may utilize a customer device 531 such as a customer's computer or mobile device. User device 531 may be a customer's computer comprised of a processor, memory, and storage; a mobile device such as a mobile phone, tablet, or wearable electronic device, etc. to interface to local retail center 520 and/or remote processing server 510 for uploading tax information directly. Mobile Scanner 532 may be a computer comprised of a processor, memory, and storage (for example, a laptop computer, a portable scanner, a mobile device such as a mobile phone, tablet, or wearable electronic device, etc. for outside customer service rep 533 to interface to local retail center 520 or central processing center 510. Mobile customer service rep 533 an individual who performs customer information collection through a plurality of means (for example, using a mobile device to capture images of customer information, using a portable scanner, to scan documents, etc.). Tax client (in the home) 534 may be customer who benefits form the services of the instant invention.

Workflow router 540 routes tax information submitted through scan server 517 from, for example, retail center 520 or customer home 530. In some embodiment, workflow router sends the tax information to character recognition manager 543 for recognizing elements within the return that may identify the best CPA 518 via user device 516 or remote worker CPA 551 via user device 550 to handle the case. In this regard, workflow router 540 may request a list of best CPA 518 skills (via user device 516) or remote worker CPA 551 skills (via user device 550) from central database 512 to determine the best CPA 518 to handle the case. In a preferred embodiment, workflow router 540 will combine skill level with CPA 518 (or remote worker CPA 551) scoring from scoring manager 541 to further refine the best CPA 518 to handle the tax information currently being routed. In some embodiments, skills may be determined automatically by workflow router 540 based on specific form, for example an agent who has a pre-configured skill with foreign tax credits, if IRS form 1116 Foreign Tax Credit is included in the documents from the client, it may be routed to an agent with a corresponding skill. In other embodiments, skills are derived automatically by workflow router 540 from specific line numbers in a tax form (for example, an IRS 1040 form) and based on line numbers with a non-zero value provided by a client, workflow router would then select one or more agents who with the required skills would be designated to receive a request to work on the client's tax preparation. It can be appreciated with one skilled in the art that several interaction routing engines could be used to route the interaction to the best CPA. Scoring manager 541 may be information pertaining to, for example, the historical performance, for example, average speed of return completion of one or more CPAs 518 or remote worker CPA 551. In another embodiment, scoring manager 541 may score based on customer surveys or recommendations. In another embodiment, scoring manager 541 may score based on social media results. In another embodiment, workflow router 540 may route tax information to user device 550 so that remote worker 551 may work on the tax information task. In some embodiments, scoring manager 541 may score CPAs based, in part, on how many returns they have prepared based on individual lines within a particular form, for example, line 10 of IRS form 1116. In this regard, if a CPA has prepared many from 1116 and had utilized line 10, scoring manager may score the agent highly on preparing form 1116 and the subject matter in which line 10 corresponds.

In a preferred embodiment, obfuscation manager 542 analyzes individual elements of the tax information from character recognition manager 543. That is, after a scanned document is received, character recognition manager 543 performs a complete optical character recognition to segment each section of the tax document (for example, identify a value for each individual line of a return) to be used in a number of ways including, but not limited to, calculating values, searching documents for particular data (for example, for workflow routing purposes). It can be appreciated by one with ordinary skill that having readable text from scanned document, would be a benefit for processing tax information intelligently. Any customer identifying information may be obfuscated by for example assigning a customer number that corresponds to a customer name or social security number. Central database 512 may keep a table with obfuscated customer numbers that are allocated to the corresponding customer name or social security number. Obfuscation allows for the secure preparation of tax returns by remote worker 551 by not having any customer identifying information. That is, all customer identifying information remains within the secure central processing server 511 in the central database 512. Once a tax return is prepared by remote worker 551, the completed tax return will be returned to central processing manager 511 where obfuscation manager will replace the customer identifying information, by for example, some hashed number that would keep a way to correspond all data to a hash, but not be able to correspond the information to a particular individual. In some embodiments the tax return may be returned to customer 534. In another embodiment, tax preparation manager 513 may transmit the tax return to a tax authority, for example the IRS, state or local government agencies.

### Detailed Description of Exemplary Embodiments

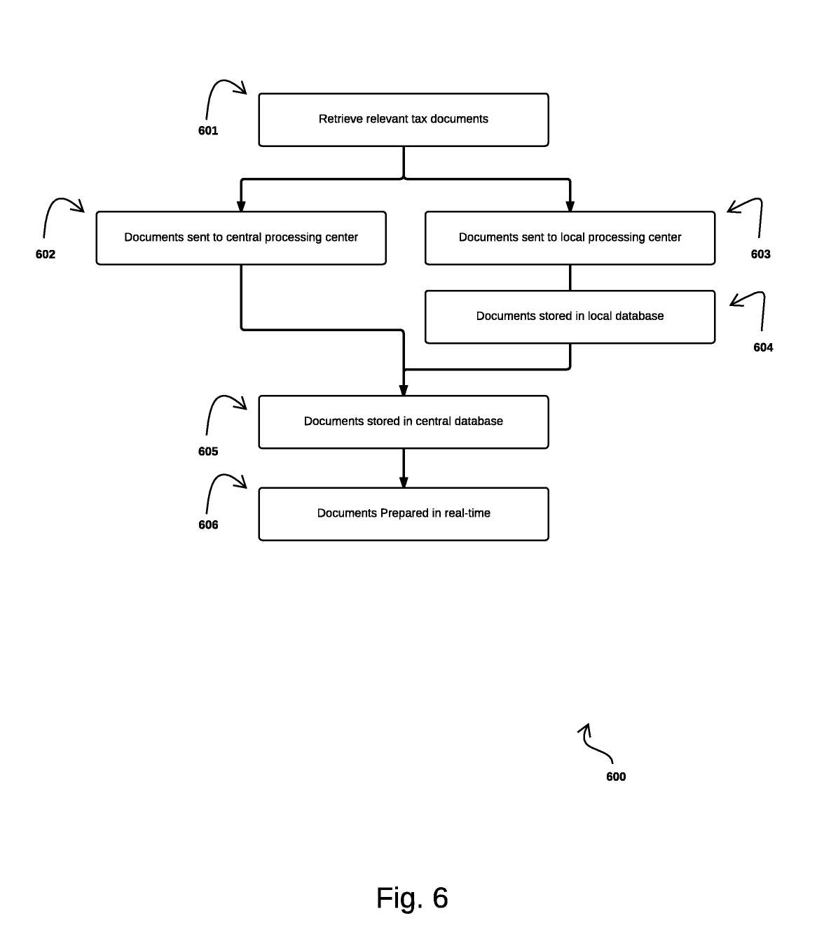

FIG. 6 is a block diagram of an exemplary method of remote tax preparation. In step 601, the relevant tax documents are retrieved, for example, via scan server 527 at retail center 520, via a mobile scanner 532 at customer home 530. In step 602, documents are sent to remote processing center 510 via cloud 501 for processing. In step 605, documents are stored in central database 512. In step 606, documents are prepared in real-time by a plurality of CPAs 518 and/or remote worker CPA 551. In another embodiment, in step 603, documents are sent to retail center 520. In step 604, documents are stored in local database 522. In step 605 documents are sent to central database 512. In step 606 documents are processed in real-time by a one or more CPAs 518 or remote worker CPA 551.

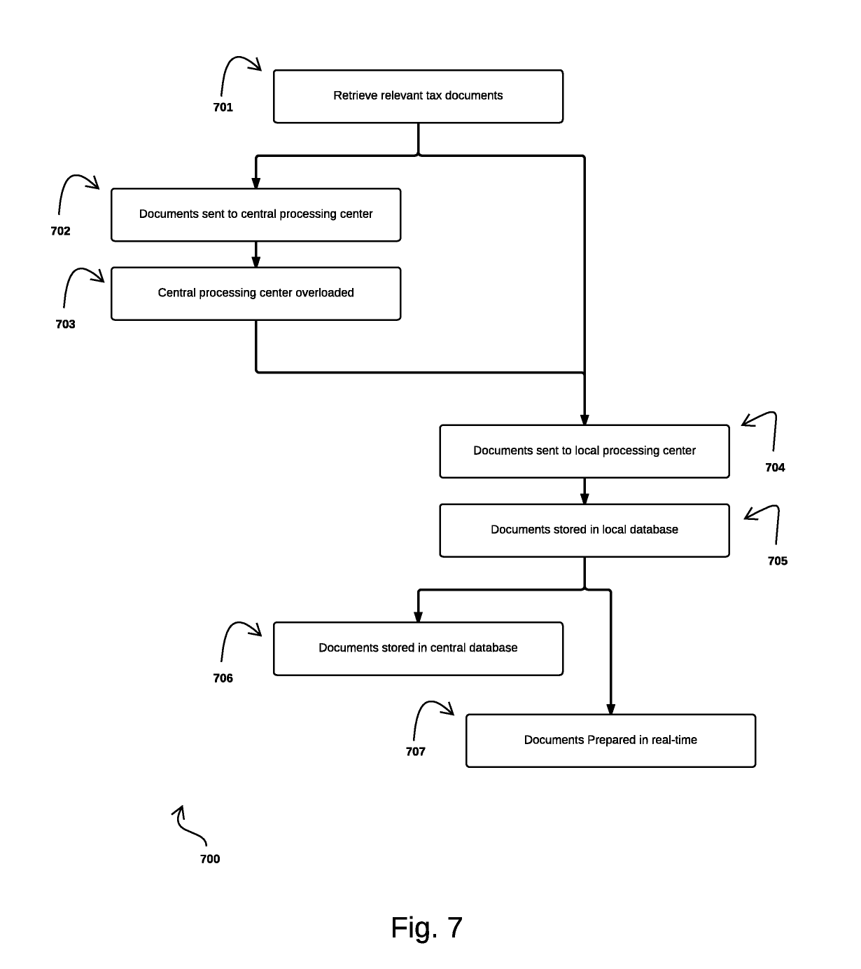

FIG. 7 is a block diagram of an exemplary method of remote tax preparation with capacity failover. In step 701, tax documents are retrieved, for example, by user device 531 at customer home 530 or by user device 526 at retail center 520. In step 702, documents are sent to central processing center 510 and received by scan server 517. Document processing manager 515 determines that the remote processing center is overloaded. Scan server 517 returns the documents to retail center 520 and document processing manager 525 sends the documents to transcription manager 524. In step 705, documents are stored in local database 522. In step 706, documents are resent to remote processing server to be stored in central database 512 (for example, for backup purposes). In step 707, documents are prepared in real-time.

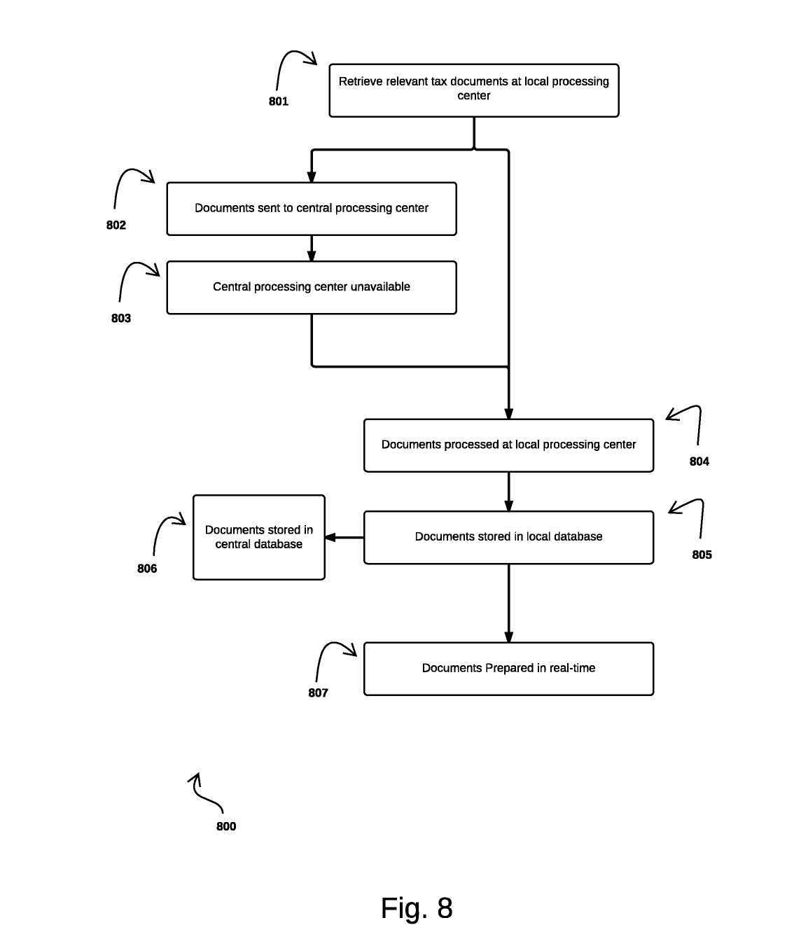

FIG. 8 is a block diagram of an exemplary method of a highly available remote tax preparation system. In step 801, tax documents are retrieved, for example, by walk-in customers 529, user mobile scanner 532 at customer home 530, or by user device 526 at retail center 520. Instep 802, scan server 527 sends documents to central processing server 511 of remote processing center 510. In step 803, it is determined by scan server 527 that a connection to remote processing center 510 cannot be reached. In step 804, Scan server 527 sends documents to local processing server 521 for local processing. In step 805, documents are stored in local database 522. In step 807, documents are prepared in real-time, by one or more customer service reps 528. In step 806, when a connection to remote processing center 510 is re-established, documents are backed up at central database 512.

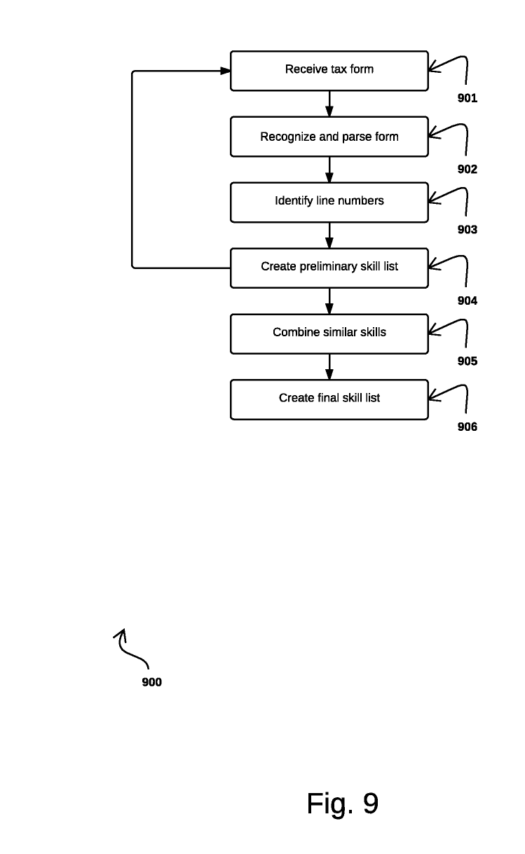

FIG. 9 is a flow diagram of an exemplary method of automatically identifying skills for a tax preparation system, according to a preferred embodiment of the invention. According to the embodiment, in a first step 901 a tax form (for example 1040, 1040NR, W-9, W-4, 1099, etc.) is received by document processing manager 515. The tax form can be received a number ways including, but not limited to user device 516 from an on-site user (for example, images from a mobile phone, images from a digital camera. documents from a wand scanner, etc.), scan server 517 which may be a flatbed image scanner, duplex scanner, portable scanner, or the like. In some embodiments a scanned image may come from a user device 526 or a scan server 527 from retail center 520. In some embodiments a scanned image may come from a user device 531 or mobile scanner 532 from customer home 530. In a next step 902, the form is recognized and parsed by character recognition manager 543 by electronic conversion of images of typed, handwritten or printed text into machine-encoded text. It can be appreciated that a number of optical character recognition (OCR) algorithms known in the art may be used to recognize text in the received document. In a next step 903, individual line items (for example, lines that have indication that require information to be entered, hereinafter referred to as an input indicators) are identified from the OCR recognized form. In some embodiments, an input indicator is a numbered line or box, in other embodiments an identifier is assigned if no pre-existing character indicator is present in the form. For example, lines of a tax form where one may put numeric values to complete a tax form (for example form 1040 line 7 “wages, salaries, tips, etc.”, line 20a “social security benefits, etc.”) In a next step 904 a preliminary skill list is created by workflow router 540 from all available lines from the recognized form. In some embodiment a pre-defined skill will be assigned to each line of a tax form (for example, form 1040 lines 12 and 24 “business income” and “business expenses” may each be assigned a skill of “business-employment”, form 1040 line 45 “alternative minimum tax” would be assigned a skill “alternative minimum tax”, etc.) In a next step 905, workflow router 540 may combine similar skills into an aggregated list, for example, skills based on a plurality of lines that refer to a similar tax concept (that is, a concept that would require similar professional skills to prepare information based on the concepts in the tax form lines), for example form 1040 line 12 and form 1040 line 24 both refer to business income, in this regard a CPA skilled in business and self-employment may a suitable choice to prepare the return). In some embodiments the aggregated list will be a subset of the complete list. In step 906 a final skill list is created by workflow router 540 to aggregate the skill list.

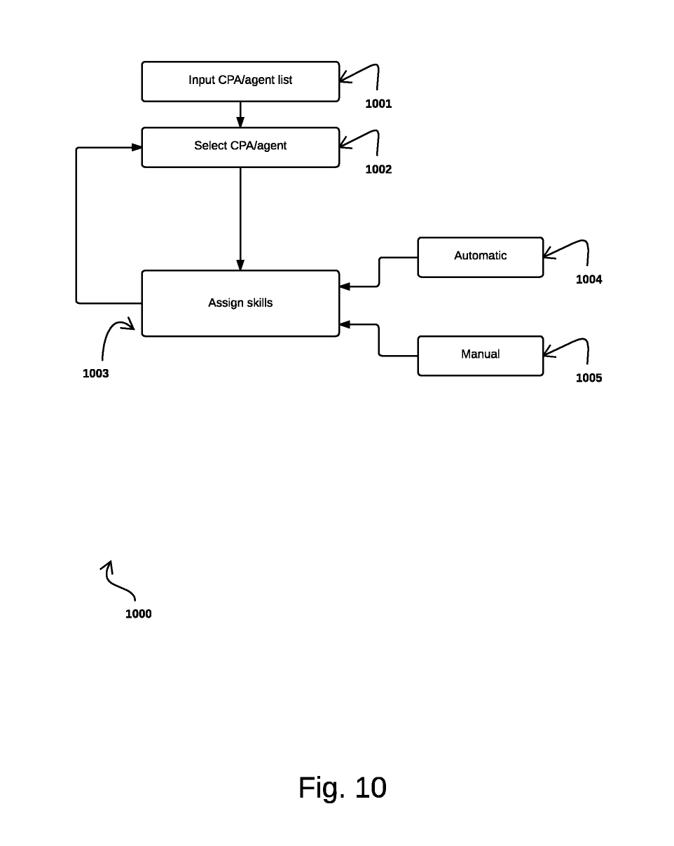

FIG. 10 is a flow diagram of an exemplary method of assigning skills to tax preparers in a tax preparation system, according to a preferred embodiment of the invention. In a first step 1001, a list of CPAs (or agents) available to prepare tax returns are inputted into workflow router 540 by an administrator. In some embodiments an administrator may access system 510 via user device 516. In other embodiments, an administrator may access system 510 remotely through cloud 501. In a next step 1002, the administrator selects a first agent. In step 1003, the administrator assigns one or more skills to the CPA by manually selecting a skill from a final skill list from step 906 (see FIG. 9). In some embodiments, skills will be automatically assigned in step 1004 by results from scoring manager 541. Scoring manager 541 may comprise information pertaining to, for example, the historical performance, for example, average speed of return completion of one or more CPAs 518 or remote worker CPA 551, number of returns prepared for a particular skill, etc. In another embodiment, scoring manager 541 may score based on customer surveys or recommendations. In some embodiments, scoring manager may dynamically update skills and scores for CPAs while the system operates to include latest scoring information for each CPA.

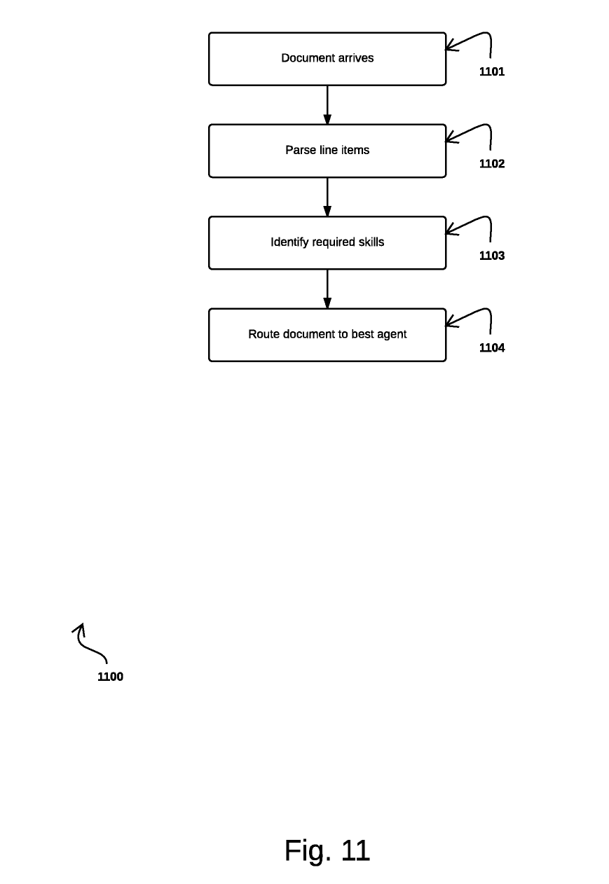

FIG. 11 is a flow diagram of an exemplary method of automatically routing tax information to the best resource in a tax preparation system, according to a preferred embodiment of the invention. According to the embodiment, in a first step 1101 a tax form arrives at document processing manager 515. The tax form is recognized for text (i.e. OCR) by character recognition manager 543. In some embodiments, the form is then passed to obfuscation manager 542 to hide original data with random characters or data to protect data that is classified as personal identifiable data, personal sensitive data or commercially sensitive data (for example, customer name and SSN, company name and address, date-of-birth, etc.). it can be appreciated that various algorithms of data substitution, shuffling, number and data variance, encryption, masking, etc. may be used to obfuscate sensitive data. In a next step 1102, the form is parsed for each line item. If a line item has a non-zero (or non-null) value, a corresponding skill requirement is associated, in step 1103, to the form (as determined by skill identification in FIG. 9). In a last step 1104, workflow router 540 routes the work item (i.e. the tax form) to the best agent. It can be appreciated by one with ordinary skill that a number of interaction-assignment strategies may be used in remote processing center 510 to assign incoming forms to the most suitable CPA 518 and/or remote worker CPA 551, instead of simply choosing the next available CPA. In other embodiments, a remote worker 551 with the required skills may be chosen by assigning user device 550

The skilled person will be aware of a range of possible modifications of the various embodiments described above. Accordingly, the present invention is defined by the claims and their equivalents.

What is claimed is:

1. A remotely-deployable system for capturing tax information, comprising:
a network-connected central processing server computer comprising a plurality of programming instructions stored in a memory and operating on a processor and configured to accept and process tax information comprising:
a user device;
a scan server;
a local transcription manager;
wherein a plurality of tax documents are captured by the user device;
wherein the scan server transmits the plurality of tax documents to a centralized processing center for processing;
wherein upon an overload of the centralized processing center, the scan server redirects the plurality of tax documents to the local transcription manager for processing;
wherein upon a network connection failure the scan server redirects the plurality of tax documents to the local transcription manager for processing.

3. The system of claim 1, further comprising:
a local database;
wherein upon an overload of the centralized processing center or a network connection failure, the scan server stores the plurality of tax documents in the local database.

4. The system of claim 3, wherein upon the centralized processing center no longer being overloaded, the scan server retransmits the plurality of tax documents to the centralized processing center for processing.

5. The system of claim 3, wherein upon the network connection is re-established, the scan server transmits the plurality of tax documents to the centralized processing center for processing.

6. The system of claim 1, further comprising:
a document processing manager;
wherein the document processing manager is configured to received tax documents via the network for local processing.

7. The system of claim 3, wherein the local database maintains a plurality of customer profile information to facilitate routing of tasks.

8. The system of claim 1, wherein the user device is capable of viewing customer data from the centralized processing center.

9. A method for capturing tax information, comprising:
a network-connected processing server computer comprising a plurality of programming instructions stored in a memory and operating on a processor and configured to accept and process tax information comprising the steps of:
capturing, at a user device, a plurality of tax documents;
transmitting, by the scan server, the plurality of tax documents to a centralized processing center for processing;
wherein upon an overload of the centralized processing center, redirecting, by the scan server, the plurality of tax documents to the local transcription manager for processing;
wherein upon a network connection failure, redirecting, by the scan server, the plurality of tax documents to the local transcription manager for processing.

10. The system of claim 9, further comprising the step of:
wherein upon an overload of the centralized processing center or a network connection failure, storing, by the scan server, the plurality of tax documents in a local database.

11. The method of claim 10, wherein upon the centralized processing center no longer being overloaded, retransmitting, by the scan server, the plurality of tax documents to the centralized processing center for processing.

12. The method of claim 10, wherein upon the network connection is re-established, retransmitting, by the scan server, the plurality of tax documents to the centralized processing center for processing.

13. The method of claim 9, further comprising the step of receiving, at a document process manager, tax documents via the network for local processing.

14. The method of claim 10, further comprising the step of maintaining, at the local database, a plurality of customer profile information to facilitate routing of tasks.

15. The method of claim 9, further comprising the step of viewing, at a user device, customer data from the centralized processing center.
